(19) United States
(12) Patent Application Publication
(10) Pub. No.: US 2013/0012644 A1
(43) Pub. Date: Jan. 10, 2013

(54) Carbon Fiber Composite Material, Oilfield Apparatus Thereof, and Method for Manufacture of The Same

(75) Inventors: Ken'ichi Niihara, Ueda-shi (JP); Toru Noguchi, Nagano-shi (JP); Hiroyuki Ueki, Nagano-shi (JP); Shigeki Inukai, Nagano-shi (JP); Masaei Ito, Sagamihara-shi (JP)

(73) Assignees: SCHLUMBERGER TECHNOLOGY CORPORATION, Sugar Land, TX (US); SHINSHU UNIVERSITY, Nagano (JP); NISSIN KOGYO CO., LTD., Ueda-shi (JP)

(21) Appl. No.: 13/523,885

(22) Filed: Jun. 15, 2012

Related U.S. Application Data
(60) Provisional application No. 61/504,312, filed on Jul. 5, 2011.

(51) Int. Cl. C08L 23/16; C08K 3/04; B82Y 30/00; B82Y 40/00

(52) U.S. Cl. 524/495; 977/742; 977/900; 977/750; 977/752

(57) ABSTRACT

A carbon fiber composite material (50) includes an elastomer, and carbon nanofibers dispersed in the elastomer in an amount of 0.01 to 0.70 parts by mass based on 100 parts by mass of the elastomer, the carbon nanofibers having an average diameter of 0.4 to 7.0 nm. A method of producing a carbon fiber composite material includes mixing carbon nanofibers having an average diameter of 0.4 to 7.0 nm into an elastomer in an amount of 0.01 to 0.70 parts by mass based on 100 parts by mass of the elastomer, and tight-milling the mixture at 0 to 50° C. using an open roll at a roll distance of 0.5 mm or less to obtain a carbon fiber composite material (50).

### BACKGROUND OF THE INVENTION

The present invention relates to a carbon fiber composite material using carbon nanofibers, an oilfield apparatus using a carbon fiber composite material, and a method of producing a carbon fiber composite material.

Carbon nanofibers have a difficulty in being disentangled and uniformly dispersed in a matrix (e.g., elastomer) because carbon nanofibers easily aggregate. JP-A-2005-97525 proposes a unique method of producing a carbon fiber composite material, wherein a strong shear force is applied to an elastomer so that carbon nanofibers are disentangled and uniformly dispersed in the elastomer due to the elasticity and the viscosity of the elastomer and a chemical interaction of the elastomer with the carbon nanofibers.

Thin carbon nanofibers (e.g., single-walled carbon nanotubes or double-walled carbon nanotubes) are more expensive than other carbon nanofibers. Therefore, research on commercial use of such thin carbon nanofibers has not advanced. For example, a carbon fiber composite material to which a large amount of relatively thick multi-walled carbon nanofibers are added to improve the tensile strength shows a decrease in elongation at break when subjected to a tensile test. In applications in which high flexibility is required for a rubber composition, a carbon fiber composite material that exhibits an improved elongation at break has been desired. A carbon fiber composite material to which a large amount of carbon nanofibers are added to improve the tensile strength tends to exhibit poor insulating properties.

### SUMMARY

An object of the invention is to provide a carbon fiber composite material using carbon nanofibers, an oilfield apparatus using a carbon fiber composite material, and a method of producing a carbon fiber composite material.

According to a first aspect of the invention, there is provided a carbon fiber composite material comprising an elastomer, and carbon nanofibers dispersed in the elastomer in an amount of 0.01 to 0.70 parts by mass based on 100 parts by mass of the elastomer, the carbon nanofibers having an average diameter of 0.4 to 7.0 nm.

According to a second aspect of the invention, there is provided an oilfield apparatus comprising the above-described carbon fiber composite material.

According to a third aspect of the invention, there is provided a method of producing a carbon fiber composite material comprising mixing carbon nanofibers having an average diameter of 0.4 to 7.0 nm into an elastomer in an amount of 0.01 to 0.70 parts by mass based on 100 parts by mass of the elastomer, and tight-milling the mixture at 0 to 50° C. using open rolls at a roll distance of 0.5 mm or less to obtain a carbon fiber composite material.

### BRIEF DESCRIPTION OF THE SEVERAL VIEWS OF THE DRAWING

FIG. 1 is a view schematically illustrating a method of producing a carbon fiber composite material.

FIG. 2 is a view schematically illustrating a method of producing a carbon fiber composite material.

FIG. 3 is a view schematically illustrating a method of producing a carbon fiber composite material.

FIG. 4 is a cross-sectional view schematically illustrating a logging-while-drilling tool according to one embodiment of the invention.

FIG. 5 is a cross-sectional view schematically illustrating a logging tool according to one embodiment of the invention.

FIG. 6 illustrates an electron micrograph of DWCNT used in the examples.

FIG. 7 illustrates an electron micrograph of DWCNT used in the examples.

FIG. 8 illustrates an electron micrograph of the tensile fractured surface of a carbon fiber composite material of Example 5.

FIG. 9 illustrates an electron micrograph of the tensile fractured surface of a carbon fiber composite material of Example 5.

FIG. 10 is a graph illustrating tensile strength with respect to the amount of carbon nanofibers (Examples 1 to 8 and Comparative Examples 1 to 8).

FIG. 11 is a graph illustrating elongation at break with respect to the amount of carbon nanofibers (Examples 1 to 8 and Comparative Examples 1 to 8).

FIG. 12 is a graph illustrating tensile strength with respect to the amount of carbon nanofibers (Examples 9 and 10 and Comparative Examples 9 to 14).

FIG. 13 is a graph illustrating elongation at break with respect to the amount of carbon nanofibers (Examples 9 and 10 and Comparative Examples 9 to 14).

FIG. 14 is a graph illustrating volume resistivity with respect to the amount of carbon nanofibers (Examples 1 to 8 and Comparative Examples 1 to 8).

FIG. 15 is a graph illustrating volume resistivity with respect to the amount of carbon nanofibers (Examples 9 and 10 and Comparative Examples 9 to 14).

### DETAILED DESCRIPTION OF THE EMBODIMENT

According to the invention, there is provided a carbon fiber composite material including an elastomer, and carbon nanofibers dispersed in the elastomer in an amount of 0.01 to 0.70 parts by mass based on 100 parts by mass of the elastomer, the carbon nanofibers having an average diameter of 0.4 to 7.0 nm.

The carbon fiber composite material according to the invention exhibits high tensile strength and a large elongation at break when subjected to a tensile test even if the carbon fiber composite material includes only a small amount of carbon nanofibers. The carbon fiber composite material according to the invention also has an economic advantage since the carbon fiber composite material exhibits high tensile strength and a large elongation at break even if only a small amount of relatively expensive carbon nanofibers are used.

The carbon fiber composite material according to the invention may have a volume resistivity of 1.0×10⁸ ohms·cm or more.

In the carbon fiber composite material according to the invention, the carbon nanofibers may have an average diameter of 0.4 to 5.0 nm.

In the carbon fiber composite material according to the invention, the carbon nanofibers may include at least one of single-walled carbon nanotubes and double-walled carbon nanotubes in an amount larger than that of multi-walled carbon nanotubes.

In the carbon fiber composite material according to the invention, the elastomer may be a natural rubber, and the carbon fiber composite material may have an elongation at break of 480% or more.

In the carbon fiber composite material according to the invention, the elastomer may be an ethylene-propylene-diene copolymer, and the carbon fiber composite material may have an elongation at break of 230% or more.

According to the invention, there is provided an oilfield apparatus using the carbon fiber composite material.

According to the invention, there is provided a method of producing a carbon fiber composite material including mixing carbon nanofibers having an average diameter of 0.4 to 7.0 nm into an elastomer in an amount of 0.01 to 0.70 parts by mass based on 100 parts by mass of the elastomer, and tight-milling the mixture at 0 to 50° C. using open rolls at a roll distance of 0.5 mm or less.

The method of producing a carbon fiber composite material according to the invention can produce a carbon fiber composite material that exhibits high tensile strength and a large elongation at break when subjected to a tensile test even if the carbon fiber composite material includes only a small amount of carbon nanofibers. The method of producing a carbon fiber composite material according to the invention also has an economic advantage since the resulting carbon fiber composite material exhibits high tensile strength and a large elongation at break even of only a small amount of relatively expensive carbon nanofibers are used.

In the method of producing a carbon fiber composite material according to the invention, the carbon fiber composite material may have a volume resistivity of 1.0×10⁸ ohms·cm or more.

In the method of producing a carbon fiber composite material according to the invention, the carbon nanofibers may have an average diameter of 0.4 to 5.0 nm.

In the method of producing a carbon fiber composite material according to the invention, the carbon nanofibers may include at least one of single-walled carbon nanotubes and double-walled carbon nanotubes in an amount larger than that of multi-walled carbon nanotubes.

The embodiments of the invention are described below in detail with reference to the drawings.

A carbon fiber composite material according to one embodiment of the invention includes an elastomer, and carbon nanofibers dispersed in the elastomer in an amount of 0.01 to 0.70 parts by mass based on 100 parts by mass of the elastomer, the carbon nanofibers having an average diameter of 0.4 to 7.0 nm.

When the carbon fiber composite material includes the carbon nanofibers in an amount of 0.01 to 0.70 parts by mass based on 100 parts by mass of the elastomer, the carbon fiber composite material exhibits high tensile strength and a large elongation at break when subjected to a tensile test. Specifically, the carbon fiber composite material exhibits excellent flexibility and strength. Carbon nanofibers are known as an expensive material. In particular, carbon nanofibers having an average diameter of 0.4 to 7.0 nm are very expensive. Therefore, it is economically advantageous since the properties of the material are improved by adding only a small amount of carbon nanofibers. The carbon fiber composite material exhibits improved tensile strength while maintaining an elongation at break when subjected to a tensile test, as compared with a rubber composition that is produced in the same manner as the carbon fiber composite material, except that the carbon nanofibers are used. The tensile strength of the carbon fiber composite material determined by a tensile test may be higher than that of the elastomer by 2.0 Mpa or more, preferably 3.0 MPa or more, and particularly preferably 3.5 MPa or more. The tensile test is performed on the carbon fiber composite material in accordance with JIS K 6251 in a state in which the elastomer is crosslinked.

The carbon fiber composite material exhibits good insulating properties. For example, the volume resistivity of the carbon fiber composite material may be 1.0×10⁸ ohms·cm or more, preferably 1.0×10¹² ohms·cm or more, and particularly preferably 1.0×10¹⁴ ohms·cm or more. The term “volume resistivity” used herein refers to the resistivity of the carbon fiber composite material per unit volume. The double-ring electrode method in accordance with JIS K 6271 may be used when the sample has a volume resistivity of 1.0×10⁴ ohms·cm or more, for example. The four-terminal four-probe method in accordance with JIS K 7194 may be used when the sample has a volume resistivity of less than 1.0×10⁴ ohms·cm, for example. An elastomer normally exhibits good insulating properties. However, when carbon nanofibers are mixed with an elastomer to improve the tensile strength, the mixture may exhibit conductivity due to a decrease in volume resistivity. Since a carbon fiber composite material may be required to exhibit insulating properties in applications such as a sealing member or a damper that comes in direct contact with an electronic part (e.g., sensor), the carbon fiber composite material according to one embodiment of the invention is particularly useful in the fields for which a carbon fiber composite material that exhibits high tensile strength and high volume resistivity is required.

At least one of the main chain, the side chain, and the terminal chain of the elastomer used for the carbon fiber composite material may include an unsaturated bond or a group having affinity to a terminal radical of the carbon nanofiber, or the elastomer may readily produce such a radical or group. The unsaturated bond or group may be at least one unsaturated bond or group selected from a double bond, a triple bond, and functional groups such as a carbonyl group, a carboxyl group, a hydroxyl group, an amino group, a nitrile group, a ketone group, an amide group, an epoxy group, an ester group, a vinyl group, a halogen group, a urethane group, a biuret group, an allophanate group, and a urea group.

Since a carbon nanofiber has a structure in which the end is closed by a five-membered ring, a carbon nanofiber easily produces a radical or a functional group. Since at least one of the main chain, side chain, and terminal chain of the elastomer molecule includes an unsaturated bond or a group having high affinity (reactivity or polarity) to the radical of the carbon nanofiber, the elastomer molecule and the carbon nanofiber can be bonded. This enables the carbon nanofibers to be easily dispersed in spite of the aggregating force of the carbon nanofibers. When mixing the elastomer and the carbon nanofibers, free radicals produced due to breakage of the elastomer molecules attack the defects of the carbon nanofibers to produce radicals on the surface of the carbon nanofibers.

As the elastomer, an elastomer such as natural rubber (NR), epoxidized natural rubber (ENR), styrene-butadiene rubber (SBR), nitrile rubber (NBR), chloroprene rubber (CR), ethylene-propylene rubber (EPR), ethylene-propylene-diene copolymer (EPDM), butyl rubber (IIR), chlorobutyl rubber (CIIR), acrylic rubber (ACM), silicone rubber (Q), fluorine rubber (FKM, FFKM, FEPM, or the like), butadiene rubber (BR), epoxidized butadiene rubber (EBR), epichlorohydrin rubber (CO or CEO), urethane rubber (U), or polysulfide rubber (T); a thermoplastic elastomer such as an olefin-based elastomer (TPO), a polyvinyl chloride-based elastomer (TPVC), a polyester-based elastomer (TPEE), a polyurethane-based elastomer (TPU), a polyamide-based elastomer (TPEA), or a styrene-based elastomer (SBS); or a mixture of thereof may be used. The elastomer may be a rubber elastomer or a thermoplastic elastomer. When using a rubber elastomer, an uncrosslinked elastomer is preferably mixed with the carbon nanofibers. When using a natural rubber as the elastomer, the elongation at break of the carbon fiber composite material determined by the tensile test may be 480% or more, and preferably 490% or more, for example. A natural rubber includes an unsaturated bond in the main chain, and easily produces radicals during mastication or mixing. Therefore, the carbon nanofibers are relatively easily dispersed in the natural rubber. When using an ethylene-propylene-diene copolymer (EPDM) as the elastomer, the elongation at break of the carbon fiber composite material determined by the tensile test may be 230% or more, for example. An ethylene-propylene-diene copolymer is non-polar, and does not include an unsaturated bond in the main chain. Therefore, the carbon nanofibers are less dispersed in the ethylene-propylene-diene copolymer as compared with a natural rubber.

The average diameter of the carbon nanofibers used for the carbon fiber composite material is 0.4 to 7.0 nm, and preferably 0.4 to 5.0 nm. The carbon nanofibers used for the carbon fiber composite may be at least one of single-walled carbon nanofibers and double-walled carbon nanofibers. The carbon nanofibers used for the carbon fiber composite material may have an average diameter of 1.0 to 3.0 nm, and may include at least one of single-walled carbon nanofibers and double-walled carbon nanofibers in an amount larger than that of multi-walled carbon nanotubes. If the carbon nanofibers have an average diameter of 0.4 to 7.0 nm, the carbon fiber composite material exhibits improved tensile strength when subjected to the tensile test even if the carbon fiber composite material includes only a small amount of carbon nanofibers. The (average) diameter of the carbon nanofibers refers to the outer diameter of the carbon nanofibers. The carbon nanofiber may be either a linear fiber or a curved fiber. The average diameter of the carbon nanofibers may be determined by measuring the diameter of the carbon nanofibers in 200 or more areas of an image photographed using an electron microscope at a magnification of 5000 (the magnification may be appropriately changed depending on the size of the carbon nanofibers), and calculating the arithmetic mean value of the measured values.

Examples of the carbon nanofibers include carbon nanotubes and the like. The carbon nanotubes may be single-walled carbon nanotubes (SWCNT) having a single hexagonal carbon layer, two-walled carbon nanotubes (DWCNT) having two hexagonal carbon layers, multi-walled carbon nanotubes (MWCNT) having three or more hexagonal carbon layers, or the like. The carbon nanofibers may include at least one of single-walled carbon nanotubes and double-walled carbon nanotubes in an amount larger than that of multi-walled carbon nanotubes. For example, commercially available single-walled carbon nanotubes may include multi-walled carbon nanotubes and double-walled carbon nanotubes in an amount smaller than that of single-walled carbon nanotubes. Single-walled carbon nanotubes may be used as the carbon nanofibers as long as the purity is 50% or more. Similarly, double-walled carbon nanotubes may be used as the carbon nanofibers as long as the purity is 50% or more. Note that the carbon nanotube may also be referred to as a graphite fibril nanotube or a vapor-grown carbon fiber.

Single-walled carbon nanotubes or double-walled carbon nanotubes may be produced to have a desired size using an arc discharge method, a laser ablation method, a vapor-phase growth method, or the like. The carbon nanofibers may be provided with improved adhesion to the elastomer or improved wettability with the elastomer by subjecting the carbon nanofibers to a surface treatment such as an ion-injection treatment, a sputter-etching treatment, or a plasma treatment before mixing the carbon nanofibers into the elastomer.

A method of producing a carbon fiber composite material according to one embodiment of the invention includes mixing carbon nanofibers having an average diameter of 0.4 to 7.0 nm into an elastomer in an amount of 0.01 to 0.70 parts by mass based on 100 parts by mass of the elastomer, and tight-milling the mixture at 0 to 50° C. using open rolls at a roll distance of 0.5 mm or less.

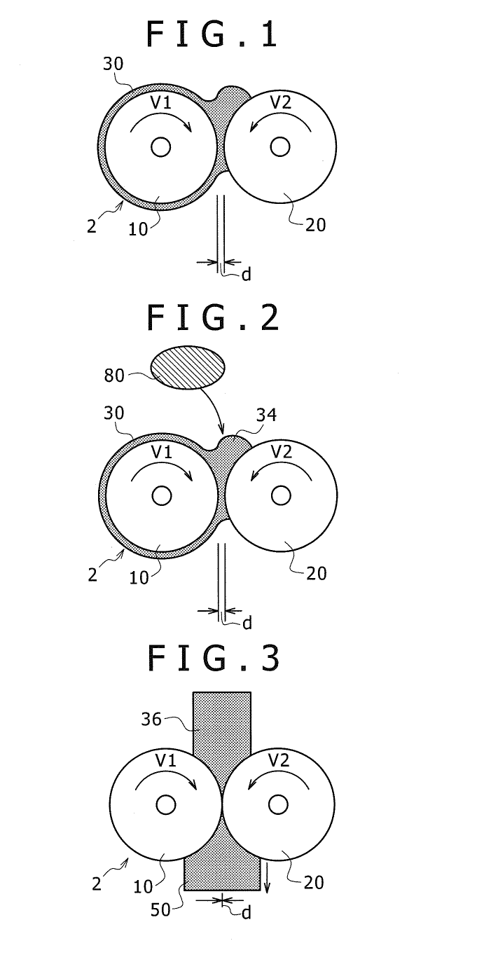

FIGS. 1 to 3 are views schematically illustrating the method of producing a carbon fiber composite material according to one embodiment of the invention.

The method of producing a carbon fiber composite material may be implemented using open rolls 2, as illustrated in FIGS. 1 to 3, for example. Specifically, a first roll 10 and a second roll 20 of the open rolls 2 are disposed at a predetermined distance d (e.g., 0.5 to 1.5 mm). The first roll 10 and the second roll 20 are respectively rotated at rotation speeds V1 and V2 in the directions indicated by arrows or in the reverse directions.

As shown in FIG. 1, an elastomer 30 that is wound around the first roll 10 is masticated so that the molecular chains of the elastomer are moderately cut to produce free radicals. The free radicals of the elastomer produced by mastication easily bond to carbon nanofibers.

As shown in FIG. 2, carbon nanofibers 80 are supplied to a bank 34 of the elastomer 30 wound around the first roll 10, and the elastomer 30 and the carbon nanofibers 80 are mixed to obtain a first mixture 36 illustrated in FIG. 3. The first mixture 36 illustrated in FIGS. 1 and 2 may be obtained using an internal mixing method, a multi-screw extrusion kneading method, or the like instead of the open-roll method.

As shown in FIG. 3, the distance d between the first roll 10 and the second roll 20 is set to 0.5 mm or less, and preferably 0 to 0.5 mm, for example. The first mixture 36 obtained in FIG. 2 is then supplied to the open roll 2, and tight-milled one or more times. The first mixture 36 may be tight-milled about one to ten times, for example. When the surface velocity of the first roll 10 is referred to as V1, and the surface velocity of the second roll 20 is referred to as V2, the surface velocity ratio (V1/V2) of the first roll 10 to the second roll 20 during tight-milling may be 1.05 to 3.00, and is preferably 1.05 to 1.2. A desired shear force can be applied by utilizing such a surface velocity ratio. A carbon fiber composite material 50 that is extruded through the narrow space between the rolls is further deformed to a large extent as a result of the restoring force of the elastomer 30 due to elasticity (see FIG. 3), so that carbon nanofibers 50 move together with the elastomer 30. The carbon fiber composite material 50 obtained by tight-milling is rolled (sheeted) by the rolls to have a given thickness (e.g., 100 to 500 micrometers). The tight-milling step may be performed while setting the roll temperature at a temperature of 0 to 50° C., and preferably at a relatively low temperature of 5 to 30° C. in order to obtain as high a shear force as possible. The measured temperature of the elastomer 30 may be adjusted to 0 to 50° C., and preferably 5 to 30° C. When using a temperature within such a range, the carbon nanofibers 80 can be dispersed due to the elasticity of the elastomer 30. This causes a high shear force to be applied to the elastomer 30 so that the aggregated carbon nanofibers are separated in such a manner that the carbon nanofibers are removed by the elastomer molecules one by one and are dispersed in the elastomer 30. Since the elastomer 30 has elasticity, viscosity, and chemical interaction with the carbon nanofibers, the carbon nanofibers can be easily dispersed. As a result, a carbon fiber composite material 50 in which carbon nanofibers have excellent dispersibility and dispersion stability (i.e., carbon nanofibers rarely reaggregate) can be obtained.

Specifically, when mixing the elastomer and the carbon nanofibers using the open rolls, the viscous elastomer enters the space between the carbon nanofibers, and specific portions of the elastomer molecules are bonded to highly active sites of the carbon nanofibers through chemical interaction. When the carbon nanofibers have a moderately active surface due to the oxidation treatment, the carbon nanofibers are easily bonded to the elastomer molecules. When a high shear force is then applied to the elastomer, the carbon nanofibers move along with the movement of the elastomer molecules so that the aggregated carbon nanofibers are separated by the restoring force of the elastomer due to its elasticity after shearing, and become dispersed in the elastomer. It is preferable to use the open-roll method because the actual temperature of the mixture can be measured and managed while managing the roll temperature. Since the carbon nanofibers that are included in the resulting carbon fiber composite material are uniformly dispersed, no carbon nanofiber aggregate may be observed in the tensile fractured surface or cross section of the carbon fiber composite material even using an electron microscope, for example.

An oilfield apparatus according to one embodiment of the invention is described below. The carbon fiber composite material may be used for an oilfield apparatus. The oilfield apparatus may be a logging tool or the like. Typical embodiments of the oilfield apparatus are described below.

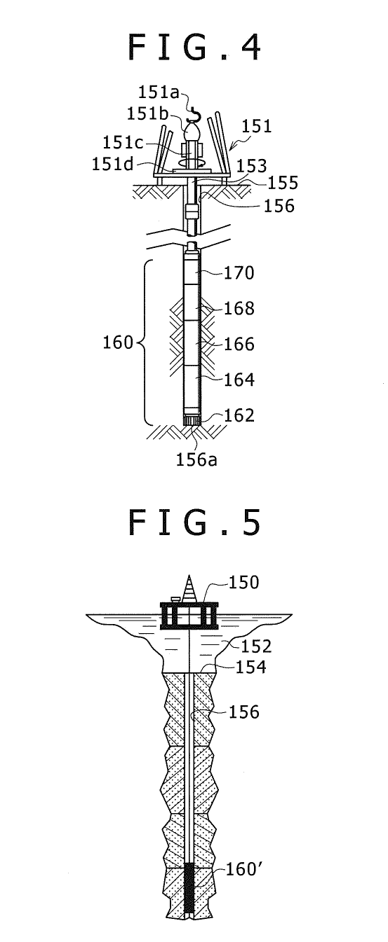

The logging tool records physical properties of a formation, a reservoir, and the like inside and around a borehole, geometrical properties (e.g., pore size, orientation, and slope) of a borehole or a casing, the flow behavior of a reservoir, and the like at each depth. For example, the logging tool may be used in an oilfield. For example, the logging tool may be used for underground applications illustrated in FIG. 4 or subsea applications illustrated in FIG. 5. The logging tool is classified as a wireline log/logging tool, a mud logging tool, a logging-while-drilling (LWD) tool, a measurement-while-drilling (MWD) tool (i.e., a measuring instrument is provided in a drilling assembly), and the like. Since these logging tools are used at a deep underground position, the carbon fiber composite material (e.g., used as a sealing member) is subjected to a severe environment. Therefore, the carbon fiber composite material may be required to exhibit high tensile strength and large elongation at break. The carbon fiber composite material may be required to further exhibit insulating properties.

FIG. 4 is a cross-sectional view schematically illustrating a logging-while-drilling apparatus according to one embodiment of the invention. FIG. 5 is a cross-sectional view schematically illustrating a logging tool according to one embodiment of the invention.

As shown in FIG. 4, when probing underground resources from ground 155 using a measuring instrument provided in a drilling assembly, a platform and a derrick assembly 151 that are disposed over a borehole 156, and a bottom hole assembly (BHA) 160 (i.e., logging tool) that is disposed in a borehole 156 (vertical or horizontal passageway) formed under the derrick assembly 151 are used, for example. The derrick assembly 151 may include a hook 151a, a rotary swivel 151b, a kelly 151c, and a rotary table 151d. The bottom hole assembly 160 is secured on the end of a long drill string 153 that extends from the derrick assembly 151, for example. Mud is supplied to the drill string 153 from a pump (not shown) through the rotary swivel 151b to drive a fluid-driven motor of the bottom hole assembly 160. The bottom hole assembly 160 includes a plurality of modules. For example, the bottom hole assembly 160 may include a drill bit 162, a rotary steerable system (RSS) 164, a mud motor 166, a measurement-while-drilling module 168, and a logging-while-drilling module 170 that are connected in this order from the end of the bottom hole assembly 160. The drill bit 162 is rotated (drills) at a bottom hole 156a of the borehole 156. The bottom hole assembly (BHA) 160 is caused to advance in a borehole 156, and the underground structure and the like are probed to determine the presence or absence of the target substance (e.g., petroleum), for example.

The measurement-while-drilling module 168 includes a measurement-while-drilling instrument (not shown) that is disposed inside a chamber provided on a wall of a pipe (drill collar) that has a thick wall. The measurement-while-drilling instrument includes batteries, capacitors, and various sensors depending on the objective of probing. For example, the measurement-while-drilling instrument measures bottom hole data (e.g., orientation, slope, bit direction, load, torque, temperature, and pressure), and transmits the measured data to the ground in real time.

The logging-while-drilling module 170 includes a logging-while-drilling instrument (not shown) that is disposed inside a chamber provided on a wall of a pipe (drill collar) that has a thick wall. The logging-while-drilling instrument includes batteries, capacitors, and various sensors depending on the objective of probing. For example, the logging-while-drilling instrument measures specific resistivity, porosity, acoustic wave velocity, gamma-rays, and the like to obtain physical logging data, and transmits the physical logging data to the ground in real time.

The carbon fiber composite material may be used in a dynamic sealing member, a static sealing member, the mud motor 166, a packer, a heat sink/vibration-resistant member, and the like of the bottom hole assembly 160, for example.

The above embodiment has been described taking an example in which the bottom hole assembly 160 includes the drill bit 162, the rotary steerable system 164, the mud motor 166, the measurement-while-drilling module 168, and the logging-while-drilling module 170. Note that the elements may be appropriately selected and combined depending on the logging application.

As shown in FIG. 5, when probing subsea resources using a wireline log/logging tool, a downhole apparatus 160′ (i.e., logging tool) is caused to advance in a borehole 156 (vertical or horizontal passageway) formed in an ocean floor 154 from a platform 150 on the sea 152, and the underground structure and the like are probed to determine the presence or absence of the target substance (e.g., petroleum), for example. The downhole apparatus 160′ is secured on the end of a long cable or communication link that extends from the platform, for example. The downhole apparatus 160′ includes a plurality of housings such as pressure vessels (not shown). Electronic instruments for electrical logging (e.g., SP logging, normal logging, induction logging, latero logging, and micro-resistivity logging), radioactivity logging (e.g., gamma-ray logging, neutron logging, formation density logging, and nuclear magnetic resonance logging), sonic logging (e.g., acoustic logging, array-sonic logging, and cement bond logging) geological information logging (e.g., dip meter and FMI), borehole seismic probing (e.g., check shot velocity logging and VSP), sampling logging (e.g., sidewall-coring logging, fluid analysis logging, RFT, and MDT), auxiliary logging (e.g., caliper measurement, borehole geometry logging, and temperature logging), special-purpose logging (logs in hostile environment), measurement through a drill pipe, and the like are selectively provided in the housing depending on the objective of probing so that the underground structure and the like can be probed. The downhole apparatus 160 is subjected to a high temperature inside the borehole 156 formed deep underground, and also subjected to vibrations and impact when the downhole apparatus 160 is caused to advance in the borehole 156.

The carbon fiber composite material may be used in a dynamic sealing member, a static sealing member, a packer, a heat sink/vibration-resistant member, and the like of the bottom hole assembly 160′, for example. Particularly, the carbon fiber composite material may be used in applications in which the carbon fiber composite material is required to exhibit excellent insulating properties (e.g., as a sealing member or a damper that directly contacts with electronic parts such as various sensors in the bottom hole assembly 160′), for example.

The carbon fiber composite material may be crosslinked by a known method. In the method of producing the carbon fiber composite material, a compounding ingredient normally used for processing an elastomer may be added. A known compounding ingredient may be used. Examples of the compounding ingredient include a crosslinking agent, a vulcanizing agent, a vulcanization accelerator, a vulcanization retarder, a softener, a plasticizer, a curing agent, a reinforcing agent, a filler, an aging preventive, a colorant, an acid acceptor, and the like. These compounding ingredients may be added to the elastomer at an appropriate timing during the mixing process.

Although only some embodiments of the invention have been described in detail above, those skilled in the art would readily appreciate that many modifications are possible in the embodiments without materially departing from the novel teachings and advantages of the invention. Accordingly, such modifications are intended to be included within the scope of the invention.

### EXAMPLES

### (1) Preparation of Samples of Examples 1 to 8 and Comparative Examples 1 to 8

100 parts by mass (phr) of a natural rubber having a weight average molecular weight of about 3,000,000 was supplied to 6-inch open rolls (roll temperature: 10 to 30° C., roll distance: 1.0 mm or less), and wound around the roll. After masticating the natural rubber for 5 minutes, carbon nanofibers (“DWCNT”, “SWCNT”, or “MWCNT” in Table 1 to 3) in a predetermined amount shown in Table 1 to 3 were added to the natural rubber. The resulting first mixture was removed from the open rolls. After reducing the roll distance to 0.1 mm or less, the first mixture was supplied to the open rolls again, and tight-milled 5 times. The surface velocity ratio of the rolls was set to 1.1. After setting the roll distance to 1.1 mm, the carbon fiber composite material obtained by tight-milling was supplied to the open rolls, and sheeted. After the addition of a predetermined amount of a crosslinking agent to the carbon fiber composite material, the mixture was sheeted, placed in a die, and subjected to press-crosslinking at 165° C. and 100 kgf/cm² for 20 minutes to obtain a carbon fiber composite material sample (carbon fiber composite material samples of Examples 1 to 8 and Comparative Examples 1 to 8). In Comparative Example 1, the natural rubber was crosslinked without using the carbon nanofibers.

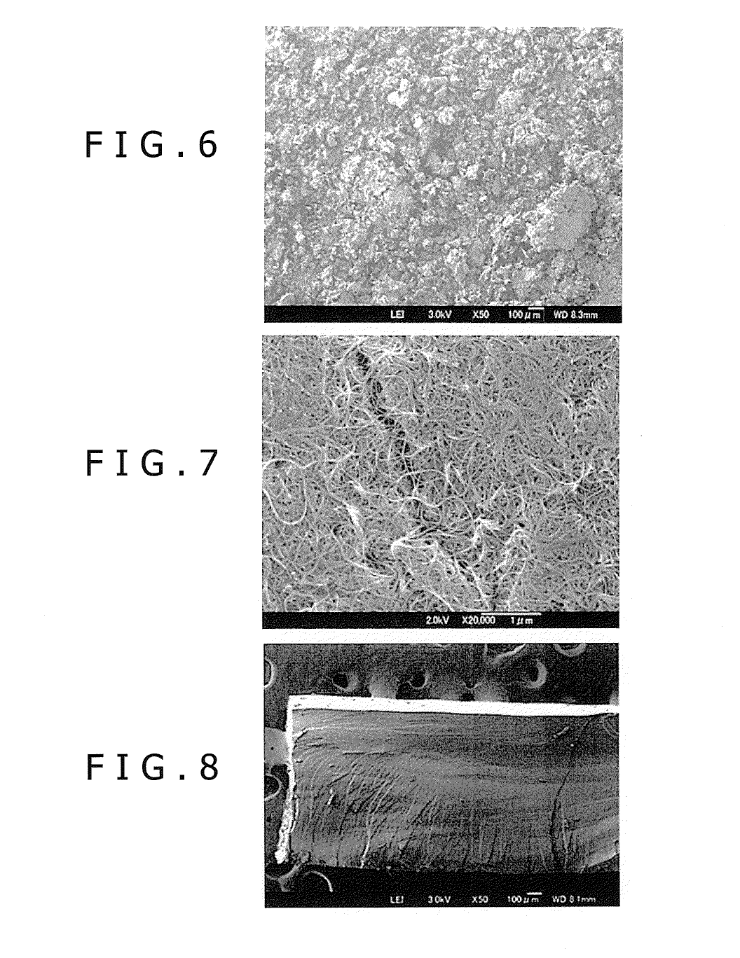

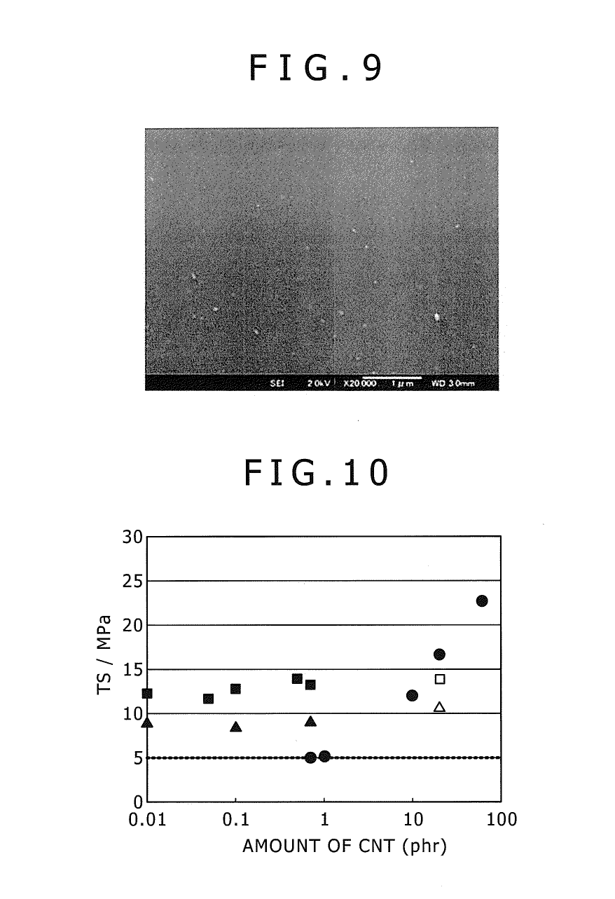

Electron micrographs of the double-walled carbon nanotubes (raw material) used in Examples 1 to 8 are shown in FIG. 6 (magnification: 50) and FIG. 7 (magnification: 20,000). Electron micrographs of the tensile fractured surface of the carbon fiber composite material of Example 5 are shown in FIG. 8 (magnification: 50) and FIG. 9 (magnification: 20,000). As shown in FIGS. 8 and 9, since the double-walled carbon nanotubes had been uniformly dispersed in the natural rubber, an aggregate of the double-walled carbon nanotubes was not observed in the tensile fractured surface of the carbon fiber composite material.

### (2) Preparation of Samples of Examples 9 and 10 and Comparative Examples 9 to 14

100 parts by mass (phr) of an ethylene-propylene-diene copolymer (“EPDM” in Tables 4 and 5) was supplied to 6-inch open rolls (roll temperature: 10 to 30° C., roll distance: 1.0 mm or less), and wound around the roll. Carbon nanofibers (“DWCNT” or “MWCNT” in Tables 4 and 5) in a predetermined amount shown in Table 4 and 5 were supplied to the ethylene-propylene-diene copolymer. The ethylene-propylene-diene copolymer and the carbon nanofibers were subjected to a first mixing step, and then removed from the open rolls. The mixture was again supplied to the open rolls (roll temperature: 100° C.), subjected to a second mixing step, and removed from the open rolls. The resulting mixture was tight-milled 5 times using the open rolls (roll temperature: 10 to 20° C., roll distance: 0.3 mm). The surface velocity ratio of the rolls was set to 1.1. An organic peroxide and a co-crosslinking agent were mixed into the uncrosslinked sheet obtained by tight-milling. The mixture was supplied to the open rolls (roll distance: 1.1 mm), and sheeted. The resulting sheet was cut into a die size, placed in a die, and compression-molded at 175° C. and 100 kgf/cm² for 20 minutes to obtain a crosslinked carbon fiber composite material sample (thickness: 1 mm) (crosslinked carbon fiber composite material samples of Examples 9 and 10 and Comparative Examples 9 to 14). An ethylene-propylene-diene copolymer “EP24” (manufactured by JSR Corporation, Mooney viscosity (ML_{1|4},125° C.): 42, ethylene content: 54 mass %, diene content: 4.5 mass %) was used as the ethylene-propylene-diene copolymer (EPDM).

Double-walled carbon nanotubes having an average diameter of 3.0 nm (“DWCNT” in Table 1), single-walled carbon nanotubes having an average diameter of 1.0 nm (“SWCNT” in Table 2), and multi-walled carbon nanotubes having an average diameter of 13.0 nm (“MWCNT” in Tables 3 and 5) were used as the carbon nanofibers used in the examples and comparative examples.

### (3) Measurement of Ordinary-State Properties

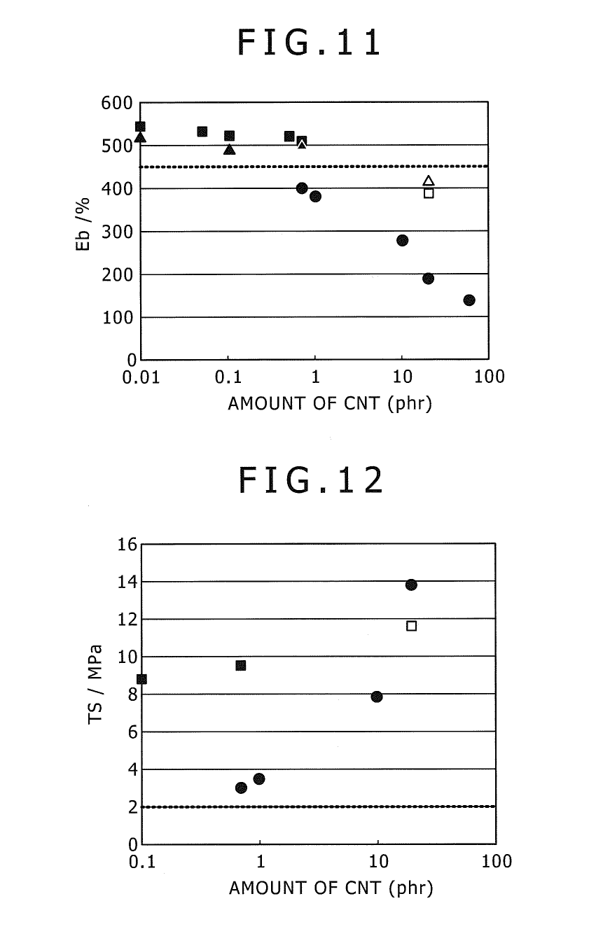

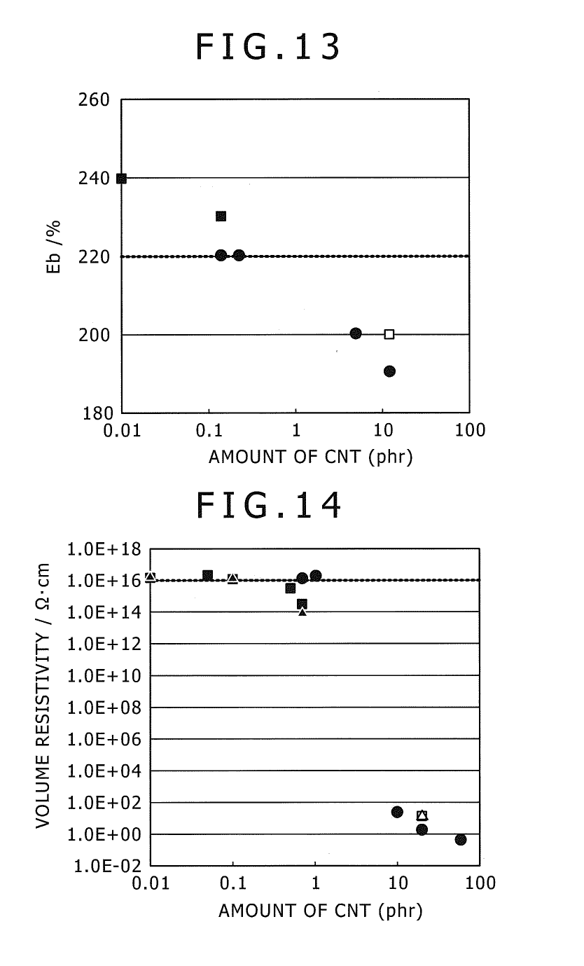

The hardness, the tensile strength, and the elongation at break of each of the crosslinked carbon fiber composite material samples of Examples 1 to 10 and Comparative Examples 1 to 14 were measured at room temperature. The measurement results are shown in Tables 1 to 5. FIGS. 10 and 12 illustrate the relationship between the content of the carbon nanofibers and the tensile strength of the carbon fiber composite material sample, and FIGS. 11 and 13 illustrate the relationship between the content of the carbon nanofibers and the elongation at break of the carbon fiber composite material sample. In FIGS. 10 and 11, black squares indicate Examples 1 to 5, black triangles indicate Examples 6 to 8, a dashed line indicates Comparative Example 1, a square indicates Comparative Example 2, a triangle indicates Comparative Example 3, and black circles indicate Comparative Examples 4 to 8. In FIGS. 12 and 13, black squares indicate Examples 9 and 10, a dashed line indicates Comparative Example 9, a square indicates Comparative Example 10, and black circles indicate Comparative Examples 11 to 14.

The rubber hardness (“Hs (JIS-A)” in Tables 1 to 5) was measured in accordance with JIS K 6253.

A JIS No. 6 dumbbell specimen was prepared by cutting the crosslinked carbon fiber composite material sample. The specimen was subjected to a tensile test in accordance with JIS K 6251 at a temperature of 23±2° C. and a tensile rate of 500 mm/min using a tensile tester (manufactured by Shimadzu Corporation) to measure the tensile strength (“TS (MPa)” in Tables 1 to 5) and the elongation at break (“Eb (%)” in Tables 1 to 5).

### (4) Measurement of Volume Resistivity

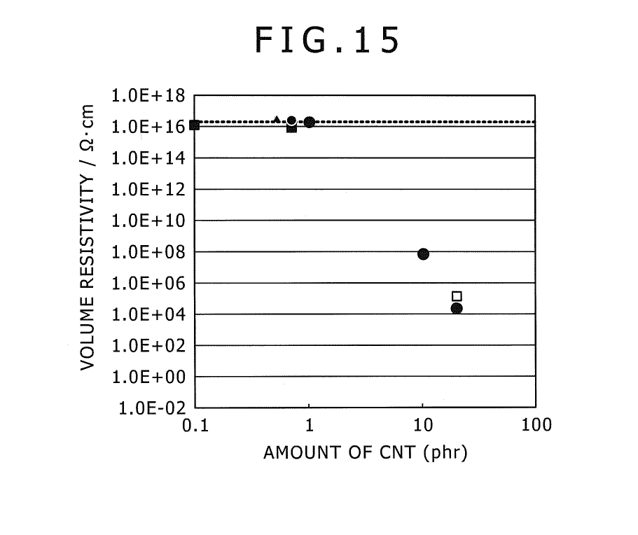

The volume resistivity (ohms·cm) of the crosslinked carbon fiber composite material samples of Examples 1 to 10 and Comparative Examples 1 to 14 was measured in accordance with JIS K 6271 or JIS K 7194. Specifically, a specimen (thickness: 1 mm) was prepared using the carbon fiber composite material sample. The volume resistivity of the specimen having a volume resistivity of 1.0×10⁴ ohms·cm or more was measured in accordance with JIS K 7194 using a system “Agilent 4339/B” (manufactured by Agilent Technologies, Inc.). The volume resistivity of the specimen having a volume resistivity of less than 1.0×10⁴ ohms·cm was measured in accordance with JIS K 6271 using a resistivity meter “Loresta-GP MCP-T610” (manufactured by Mitsubishi Chemical Corporation). The volume resistivity was measured at a temperature of 23±2° C. and an applied voltage of 10 to 1000 V. The measurement results are shown in Tables 1 to 5. FIGS. 14 and 15 illustrate the relationship between the content of the carbon nanofibers and the volume resistivity of the carbon fiber composite material. In FIG. 14, black squares indicate Examples 1 to 5, black triangles indicate Examples 6 to 8, a square indicates Comparative Example 2, a triangle indicates Comparative Example 3, black circles indicate Comparative Examples 4 to 8, and a dashed line indicates Comparative Example 1 (1.0×10¹⁶ ohms·cm). In FIG. 15, black squares indicate Examples 9 and 10, a dashed line indicates Comparative Example 9, a square indicates Comparative Example 10, black circles indicate Comparative Examples 11 to 14, and a dashed line indicates Comparative Example 9 (2.0×10¹⁶ ohms·cm).

TABLE 1

| | | | | | | | | Comparative | Comparative |
|---|---|---|---|---|---|---|---|---|---|
| | | | Example 1 | Example 2 | Example 3 | Example 4 | Example 5 | Example 1 | Example 2 |
| Component | NR | phr | 100 | 100 | 100 | 100 | 100 | 100 | 100 |
| | DWCNT | phr | 0.01 | 0.05 | 0.1 | 0.5 | 0.7 | 0 | 20 |
| | Crosslinking agent | phr | 2 | 2 | 2 | 2 | 2 | 2 | 2 |
| Ordinary-state | Hs | JISA | 40 | 39 | 36 | 37 | 37 | 42 | 58 |
| properties | TS | MPa | 12.1 | 11.6 | 12.7 | 13.8 | 13.2 | 50 | 13.9 |
| | Eb | % | 540 | 530 | 520 | 520 | 510 | 550 | 390 |

| | | | | | | | | |
|---|---|---|---|---|---|---|---|---|
| Volume resistivity | ohms · cm | 1.3E+16 | 1.9E+16 | 1.1E+16 | 3.1E+15 | 3.1E+14 | 1.0E+16 | 1.5E+01 |

TABLE 2

| | | | | | | Comparative |
|---|---|---|---|---|---|---|
| | | | Example 6 | Example 7 | Example 8 | Example 3 |
| Component | NR | phr | 100 | 100 | 100 | 100 |
| | SWCNT | phr | 0.01 | 0.1 | 0.7 | 20 |
| | Crosslinking agent | phr | 2 | 2 | 2 | 2 |
| Ordinary- | Hs | JISA | 38 | 37 | 39 | 55 |
| state properties | TS | MPa | 9.0 | 8.5 | 9.2 | 10.8 |
| | Eb | % | 520 | 490 | 500 | 420 |

| | | | | | |
|---|---|---|---|---|---|
| Volume resistivity | ohms · cm | 2.3E+16 | 1.5E+16 | 1.1E+14 | 2.0E+01 |

TABLE 3

| | | | Comparative | Comparative | Comparative | Comparative | Comparative |
|---|---|---|---|---|---|---|---|
| | | | Example 4 | Example 5 | Example 6 | Example 7 | Example 8 |
| Component | NR | phr | 100 | 100 | 100 | 100 | 100 |
| | MWCNT | phr | 0.7 | 1.0 | 10 | 20 | 60 |
| | Crosslinking agent | phr | 2 | 2 | 2 | 2 | 2 |
| Ordinary- | Hs | JISA | 42 | 43 | 56 | 67 | 85 |
| state properties | TS | MPa | 4.9 | 5.1 | 12.0 | 16.6 | 22.7 |
| | Eb | % | 400 | 380 | 280 | 190 | 140 |

| | | | | | | |
|---|---|---|---|---|---|---|
| Volume resistivity | ohms · cm | 1.2E+16 | 1.9E+16 | 2.5E+01 | 2.0E+00 | 4.8E−01 |

As shown in Table 1 and FIGS. 10 and 11, the carbon fiber composite material samples of Examples 1 to 5 containing 0.01 to 0.7 parts by mass of DWCNT exhibited a tensile strength higher than that of the carbon fiber composite material sample of Comparative Example 1 that contained only the natural rubber, exhibited a large elongation at break in spite of incorporation of the carbon nanofibers, and had a volume resistivity of 1.0×10¹⁴ ohms·cm or more (i.e., had excellent insulating properties). The carbon fiber composite material sample of Comparative Example 2 containing 20 parts by mass of DWCNT exhibited a tensile strength almost equal to that of the carbon fiber composite material samples of Examples 1 to 5, but exhibited an elongation at break smaller than that the carbon fiber composite material sample of Comparative Example 1 by 160%, and had a volume resistivity of 15.0 ohms·cm.

As shown in Table 2 and FIGS. 10 and 11, the carbon fiber composite material samples of Examples 6 to 8 containing 0.01 to 0.7 parts by mass of SWCNT exhibited a tensile strength higher than that of the carbon fiber composite material sample of Comparative Example 1 that contained only the natural rubber, exhibited a large elongation at break in spite of incorporation of the carbon nanofibers, and had a volume resistivity of 1.0×10¹⁴ ohms·cm or more (i.e., had excellent insulating properties). The carbon fiber composite material sample of Comparative Example 3 containing 20 parts by mass of SWCNT exhibited a tensile strength higher than that of the carbon fiber composite material samples of Examples 6 to 8, but exhibited an elongation at break smaller than that of the carbon fiber composite material sample of Comparative Example 1 by 130%, and had a volume resistivity of 20.0 ohms·cm.

As shown Tables 1 to 3 and FIGS. 10 to 14, the carbon fiber composite material samples of Comparative Examples 4 and 5 containing 0.7 to 1.0 parts by mass of MWCNT exhibited a tensile strength almost equal to that of the carbon fiber composite material samples of Comparative Example 1, and had an elongation at break smaller than that of the carbon fiber composite material sample of Comparative Example 1 by 150% or more. The carbon fiber composite material samples of Comparative Examples 6 to 8 containing 10 parts by mass or more of MWCNT exhibited a tensile strength almost equal to or higher than that of the carbon fiber composite material samples of Examples 1 to 8, but exhibited an elongation at break smaller than that of the carbon fiber composite material samples of Examples 1 to 8 by 170% or more. The carbon fiber composite material samples of Examples 1 to 8 exhibited a volume resistivity of 1.0×10¹⁴ ohms·cm or more (i.e., had excellent insulating properties). However, the carbon fiber composite material samples of Comparative Examples 6 to 8 containing MWCNT so as to have a tensile strength almost equal to or higher than that of the carbon fiber composite material samples of Examples 1 to 8 had a volume resistivity of 25 ohms·cm or less.

TABLE 4

| | | | | | Comparative | Comparative |
|---|---|---|---|---|---|---|
| | | | Example 9 | Example 10 | Example 9 | Example 10 |
| Component | EPDM | phr | 100 | 100 | 100 | 100 |
| | DWCNT | phr | 0.1 | 0.7 | 0 | 20 |
| | Crosslinking agent | phr | 2 | 2 | 2 | 2 |
| Ordinary- | Hs | JISA | 50 | 52 | 50 | 70 |
| state properties | TS | MPa | 8.8 | 9.5 | 2.0 | 11.6 |
| | Eb | % | 240 | 230 | 220 | 200 |

| | | | | | |
|---|---|---|---|---|---|
| Volume resistivity | ohms · cm | 1.5E+16 | 1.0E+16 | 2.0E+16 | 1.5E+05 |

TABLE 5

| | | | Comparative | Comparative | Comparative | Comparative |
|---|---|---|---|---|---|---|
| | | | Example 11 | Example 12 | Example 13 | Example 14 |
| Component | EPDM | phr | 100 | 100 | 100 | 100 |
| | MWCNT | phr | 0.7 | 1.0 | 10 | 20 |
| | Crosslinking agent | phr | 2 | 2 | 2 | 2 |
| Ordinary- | Hs | JISA | 54 | 55 | 65 | 72 |
| state properties | TS | MPa | 3.0 | 3.5 | 7.8 | 13.8 |
| | Eb | % | 220 | 220 | 200 | 190 |

| | | | | | |
|---|---|---|---|---|---|
| Volume resistivity | ohms·cm | 2.6E+16 | 2.0E+16 | 8.9E+07 | 2.2E+04 |

As shown in Table 4 and FIGS. 12 and 13, the carbon fiber composite material samples of Examples 9 and 10 containing 0.01 to 0.7 parts by mass of DWCNT exhibited a tensile strength higher than that of the carbon fiber composite material sample of Comparative Example 9 that contained only EPDM, exhibited a large elongation at break in spite of incorporation of the carbon nanofibers, and had a volume resistivity of 1.0×10¹⁶ ohms·cm or more (i.e., had excellent insulating properties). The carbon fiber composite material sample of Comparative Example 10 containing 20 parts by mass of DWCNT exhibited a tensile strength almost equal to that of the carbon fiber composite material samples of Examples 9 and 10, but exhibited an elongation at break smaller than that of the carbon fiber composite material sample of Comparative Example 9. The carbon fiber composite material samples of Examples 1 to 10 using the non-polar EPDM had a tensile strength and an elongation at break similar to those of the carbon fiber composite material using the natural rubber.

As shown Tables 4 and 5 and FIGS. 12, 13, and 15, the carbon fiber composite material samples of Comparative Examples 11 and 12 containing 0.7 to 1.0 parts by mass of MWCNT did not exhibit a tensile strength significantly higher than that of the carbon fiber composite material sample of Comparative Example 9, and had an elongation at break equal to that of the carbon fiber composite material sample of Comparative Example 9. The carbon fiber composite material samples of Comparative Examples 13 to 14 containing 10 parts by mass or more of MWCNT exhibited high tensile strength, but exhibited an elongation at break smaller than that of the carbon fiber composite material sample of Comparative Example 9 by 20% or more. While the carbon fiber composite material samples of Examples 9 and 10 had a volume resistivity of 1.0×10¹⁶ ohms·cm or more (i.e., had excellent insulating properties), the carbon fiber composite material samples of Comparative Examples 13 and 14 containing MWCNT so as to exhibit a tensile strength almost equal to or higher than the tensile strength of Examples 9 and 10 had a volume resistivity of 8.9×10⁷ ohms·cm or less.

What is claimed is:

1. A carbon fiber composite material comprising an elastomer, and carbon nanofibers dispersed in the elastomer in an amount of 0.01 to 0.70 parts by mass based on 100 parts by mass of the elastomer, the carbon nanofibers having an average diameter of 0.4 to 7.0 nm.

2. The carbon fiber composite material according to claim 1, having a volume resistivity of 1.0×10⁸ ohms·cm or more.

3. The carbon fiber composite material according to claim 1,
wherein the carbon nanofibers have an average diameter of 0.4 to 5.0 nm.

4. The carbon fiber composite material according to claim 1,
wherein the carbon nanofibers include at least one of single-walled carbon nanotubes and double-walled carbon nanotubes in an amount larger than that of multi-walled carbon nanotubes.

5. The carbon fiber composite material according to claim 1,
wherein the elastomer is a natural rubber, and the carbon fiber composite material has an elongation at break of 480% or more.

6. The carbon fiber composite material according to claim 1,
wherein the elastomer is an ethylene-propylene-diene copolymer, and the carbon fiber composite material has an elongation at break of 230% or more.

7. An oilfield apparatus comprising the carbon fiber composite material according to claim 1.

8. A method of producing a carbon fiber composite material comprising mixing carbon nanofibers having an average diameter of 0.4 to 7.0 nm into an elastomer in an amount of 0.01 to 0.70 parts by mass based on 100 parts by mass of the elastomer, and tight-milling the mixture at 0 to 50° C. using open rolls at a roll distance of 0.5 mm or less to obtain a carbon fiber composite material.

9. The method according to claim 8, wherein the carbon fiber composite material has a volume resistivity of 1.0×10⁸ ohms·cm or more.

10. The method according to claim 8,
wherein the carbon nanofibers have an average diameter of 0.4 to 5.0 nm.

11. The method according to claim 8,
wherein the carbon nanofibers include at least one of single-walled carbon nanotubes and double-walled carbon nanotubes in an amount larger than that of multi-walled carbon nanotubes.
